(19) United States
(12) Patent Application Publication
(10) Pub. No.: US 2024/0394770 A1
(43) Pub. Date: Nov. 28, 2024

(54) SYSTEM AND METHOD FOR MULTI-TIERED QUERY FOR SPECIALTY PROPERTY RECOMMENDATIONS

(71) Applicant: A Place For Mom, Inc., Seattle, WA (US)

(72) Inventors: Scott Clayton, Zionsville, IN (US); Steve Feero, Cheshire, CT (US)

(73) Assignee: A Place For Mom, Inc., Seattle, WA (US)

(21) Appl. No.: 18/202,192

(22) Filed: May 25, 2023

(51) Int. Cl. G06Q 30/0601

(52) U.S. Cl. CPC G06Q 30/0631; G06Q 30/0617; G06Q 30/0627

(57) ABSTRACT

Systems, apparatuses, and methods for establishing an indexed list of specialty properties to glean recommendations for a potential customer based on a nested multi-tiered set of queries. A set of queries may be directed to one or more types of specialty properties. As the potential customer answers the first set of queries, the identification of a type of specialty property best suited to the user is determined. Once a type of care is gleaned, a second set of queries about the user's preferences is presented based on the type of care determined. As the potential customer answers the second set of queries, an indexed subset of specialty properties may be presented best suited to the user in response to the received data about the second plurality of queries. This may typically be presented in a tanked listing of top-ten choices or the like.

### BACKGROUND

Specialty property, such as senior living and assisted care facilities, are growing in demand in the United States and other countries due to a rapidly aging population. As modern medical breakthroughs allow for longer and more active lives, the demand for senior living facilities continues to rise. Determining best-suited facilities for potential consumers of specialty properties may involve a lengthy and involved process. This is typically embodied in an involved teleconference that often requires detailed involvement and touchpoints from human resources in order to ensure that applicable and suitable options are presented to prospective consumers. As consumer cost and demand for specialty property can be a difficult task with disparate information available across disparate social, geographic, econometric and demographic strata, correctly collecting and assessing initial touchpoint data is imperative in guiding potential consumers to the best options for specialty property.

Further, existing methods for collecting data from potential consumers as well as demand of senior living and similar specialty properties are based on a human interaction prone to misinterpretation and errors. Potential consumers may respond to telephonic surveys with less-than-accurate answers that may lead to a skewing of best-suited properties based on less-than-definitive answers. This application presents an invention that overcomes the limitations of existing methods by presenting a digital option for algorithmically stepping through a series of nested decision trees for determining best suited specialty properties at the time of inquiry as influenced by dynamic factors such as consumer demand, cost demand, and property availability.

### BRIEF DESCRIPTION OF DRAWINGS

The drawings described herein are for illustrative purposes only of selected embodiments and not all possible implementations and are not intended to limit the scope of the present disclosure.

FIG. 1 is a block diagram of a networked computing environment for facilitating data collection, analysis and consumption in a specialty property index and recommendation engine according to an embodiment of the present disclosure;

FIG. 2 is an exemplary computing environment that is a suitable representation of any computing device that is part of the system of FIG. 1 according to an embodiment of the present disclosure;

FIG. 3 is a block diagram of the specialty property index and recommendation engine of FIG. 1 according to an embodiment of the subject matter disclosed herein; and

FIG. 4 is a method flow chart for using the system of FIG. 1 according to an embodiment of the subject matter disclosed herein.

Corresponding reference numerals indicate corresponding parts throughout the several views of the drawings.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, or the like) that is part of a client device, server, network element, or other form of computing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Prior to discussing specific details of the embodiments described herein, a brief overview of the subject matter is presented. Generally, one or more embodiments are directed to systems, apparatuses, and methods for enabling a user to collect, assemble, manipulate, and utilize data regarding availability, cost, demand and/or matchability in one or more specific markets about specialty properties, such as assisted living, long-term care facilities, and the like. Several factors will affect a specific market and the ebb and flow of regional costs, regional demand, regional demographics, and regional econometrics. Further, intra-regional and extra-regional data may also reflect the behavior of individuals in a market based on additional factors. Collecting this data and assigning relative values to the data based on follow-on activities, such as actual inquiries into property, lead generation for specific properties and move-in data for specific properties leads to an ever-changing index of specialty properties that is continuously updated through updated machine-learning algorithms by which index data may be gleaned at any given moment in time for any specific region.

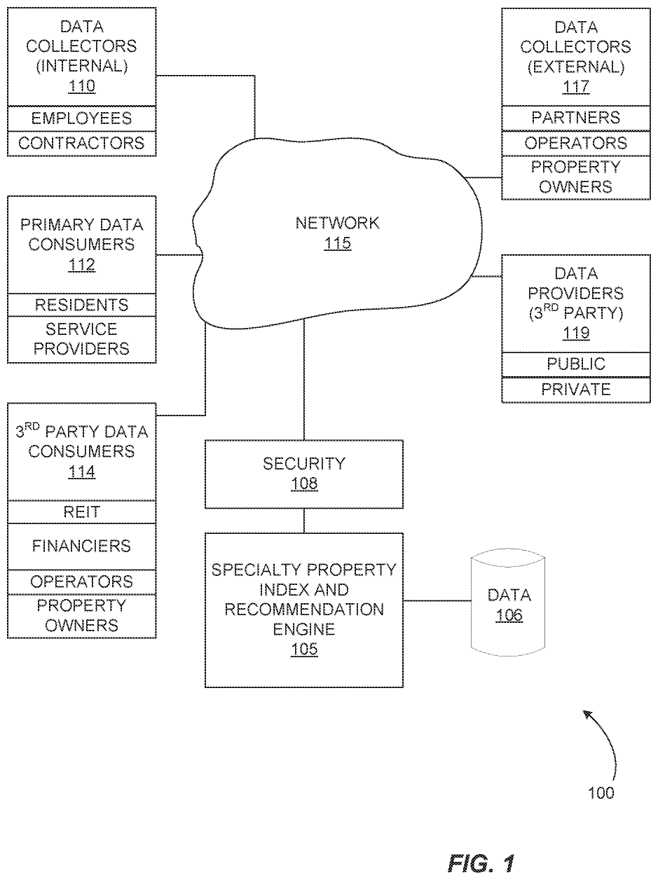

In an embodiment, a computer-based method, may include steps for establishing an indexed list of specialty properties at a server computer and presenting a first plurality of queries to an end user on a computing device that is remote from the server computer and communicatively coupled to the server computer through a computer network, the first plurality of queries directed to one or more types of specialty properties. Such an initial set of queries may be directed at determining a potential customer's type-of-care choices. As the potential customer answers the first set of queries, the method includes receiving data from the user in answer to the first plurality of queries, at the server computer, about the user's preferences for the one or more types of specialty properties to generate an identification of a type of specialty property best suited to the user in response to the received data from the first plurality of queries. Once this type of care is gleaned, the method may include a step for presenting a second plurality of queries about the user's preferences, the second plurality of queries directed to preferences about the identified type of specialty property. As the potential customer answers the second set of queries, a step for receiving data from the user in answer to the second plurality of queries, at the server computer, about the user's preferences for the identified type of specialty properties is accomplished. Upon assimilating all nested queries, the method includes a step for generating an identification of one or more recommendations for specialty properties within a set of properties that match the identified type of properties and that are best suited to the user in response to the received data about the second plurality of queries. This may typically be presented in a ranked listing of top-ten choices or the like. Such a ranked list may then be communicated to the remote computer and stored at the server computer in association with the user. These and other aspects of the specific embodiments are discussed below with respect to FIGS. 1-4.

FIG. 1 is a block diagram of a networked computing environment 100 for facilitating data collection, analysis and consumption in a specialty property index and recommendation engine according to an embodiment of the present disclosure. The environment 100 includes a number of different computing devices that may each be coupled to a computer network 115. The computer network 115 may be the internet, and internal LAN or WAN or any combination of known computer network architectures. The environment 100 may include a server computer having a specialty property recommendation engine 105 having several internal computing modules and components configured with computer-executable instructions for facilitating the collection, analysis, assembly, manipulation, storing, and reporting of data about specialty property queries, costs, and demand. The specialty property recommendation engine 105 may store the data and executable instructions in a database or memory 106. The specialty property recommendation engine 105 may also be behind a security firewall 108 that may require username and password credentials for access to the data and computer-executable instructions in the memory 106.

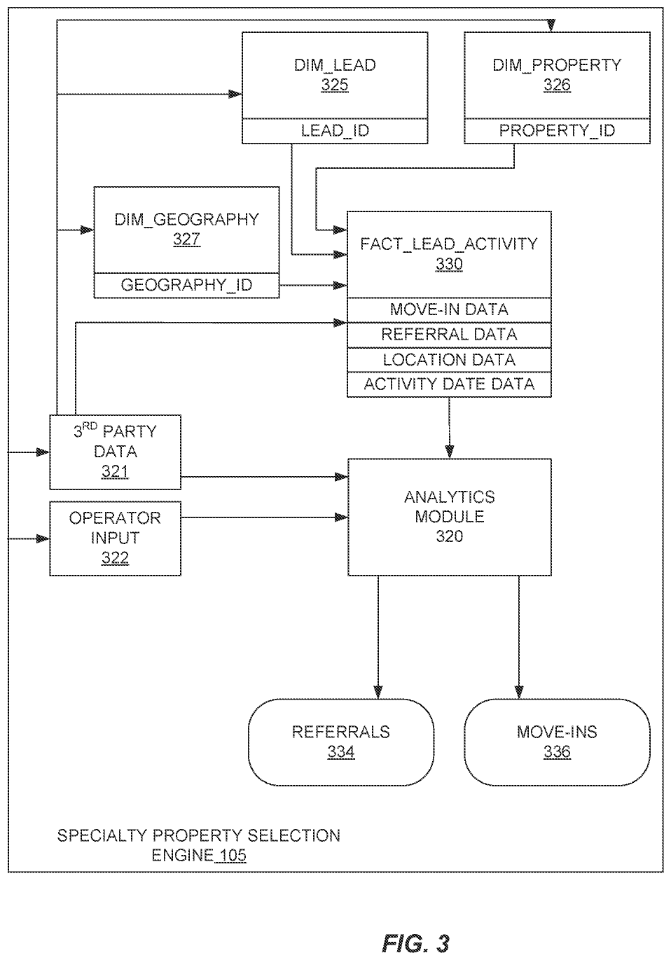

The environment 100 may further include several additional computing entities for data collection, provision, and consumption. These computing entities include internal data collectors 110, such as employee computing devices and contractor computing devices. Internal data collectors 110 may typically be associated with a company or business entity that administers the specialty property recommendation engine computer 105. As such, internal data collectors 110 may also be located behind the firewall 108 with direct access to the server computer (without using any external network 115). Internal data collectors may collect and assimilate data from various sources of data regarding specialty properties. Such data collected may include data from potential resident inquiries, leads data from advisors working with/for the business entity, and move-in data from property owners and operators. Many other examples of collected data exist but are discussed further below with respect to additional embodiments. The aspects of the specific data collected by internal data collectors 110 are described below with respect to FIG. 3.

The environment 100 may further include external data collectors 117, such as partners, operators and property owners. External data collectors 117 may typically be third-party businesses that have a business relationship with the company or business entity that administers the specialty property recommendation engine computer 105. External data collectors 117 may typically be located outside of the firewall 108 without direct access to the specialty property recommendation engine 105 such that credentials are used through the external network 115. Such data collected may include eligibility data to assess the likelihood that a user of a digital front-end system represents a real person, data from potential resident inquiries, leads data from advisors working with/for the business entity, and move-in data from property owners and operators. Many other examples of collected data exist but are discussed further below with respect to additional embodiments.

For example, one third-party system utilizes a determination algorithm to assess a likelihood of the potential customer actually being a real person. This third-party system uses name, address, and other basic information (such as phone number and email address) to determine a likelihood that the inquirer represents a bona fide individual. In one embodiment, an 85% confidence determination allows the inquiry to continue in digital format whereas less than an 85% confidence level may trigger a human interaction follow-up. In other embodiments, this percentage may be greater than or less than 85%. Further yet, such an initial inquiry and determination may also assess a potential customer's financial profile that may trigger a desire by the administering company to alter the approach to interacting with the potential customer. That is, if financial data meets a specific threshold, a method may be triggered that is better suited to potential customers having greater financial potential. Additional aspects of the specific data collected by external data collectors 117 are also described below with respect to FIG. 3.

The environment 100 may further include data from third-party data providers 119, that includes private entities such as WalkScore, Redfin, or Zillow data about walkability and living costs. In addition, the environment may include public data sources such as the American Community Survey (ACS) and US Department of Housing and Urban Development (HUD). These third-party data providers may provide geographic, econometric, and demographic data to further lend insights into the collected data about potential resident inquiries, leads, and move-in data. Many other examples of third-party data exist but are not discussed further for brevity.

The environment 100 may further include primary data consumers 112, such as existing and potential residents as well as service providers. The environment 100 may further include, and third-party data consumers 114, such as Real-Estate Investment Trusts (REITs), financiers, third-party operators, and third-party property owners. These primary data consumers 112 and third-party data consumers 114 may use the assimilated data in the database collected from data collectors and third parties to glean information about one or more specialty property markets. Such data consumed may include the very data from potential resident inquiries, leads data and move-in data. Many other examples of consumed data exist but are discussed further below with respect to additional embodiments as well as discussed in related patent applications.

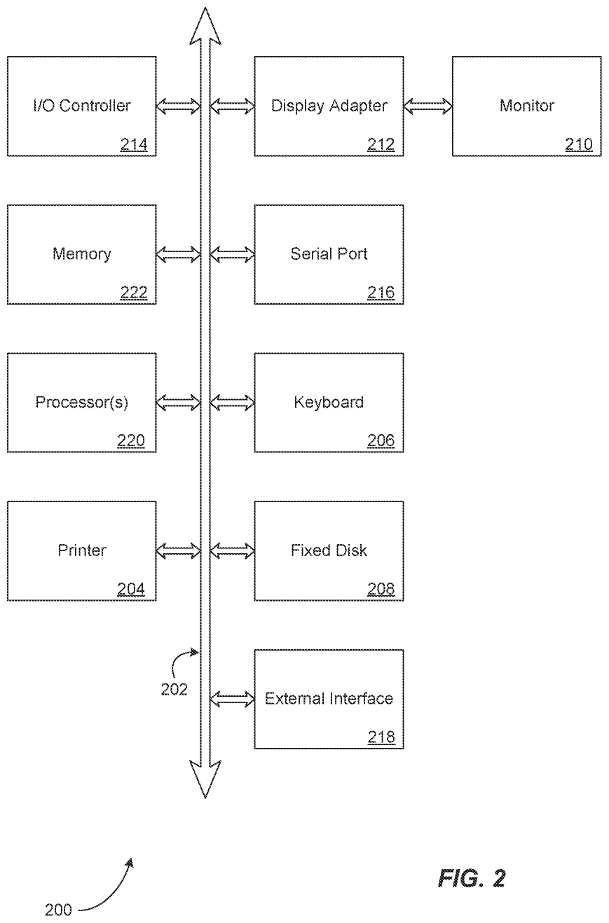

Collectively, the data collected and consumed may be stored in the database 106 and manipulated in various ways described below by the specialty property recommendation engine 105. Prior to discussing aspects of the operation and data collection and consumption as well as the cultivation of the database, a brief description of any one of the computing devices discussed above is provided with respect to FIG. 2.

FIG. 2 is a diagram illustrating elements or components that may be present in a computer device or system configured to implement a method, process, function, or operation in accordance with an embodiment. In accordance with one or more embodiments, the system, apparatus, methods, processes, functions, and/or operations for enabling efficient configuration and presentation of a user interface to a user may be wholly or partially implemented in the form of a set of instructions executed by one or more programmed computer processors such as a master control unit (MCU), central processing unit (CPU), or microprocessor. Such processors may be incorporated in an apparatus, server, client or other computing or data processing device operated by, or in communication with, other components of the system. Such computing devices may further be one or more of the group including: a desktop computer, a server computer, a laptop computer, a handheld computer, a tablet computer, a smart phone, a personal data assistant, and a rack-mounted computing device.

As an example, FIG. 2 is a diagram illustrating elements or components that may be present in a computer device or system 200 configured to implement a method, process, function, or operation in accordance with an embodiment. The subsystems shown in FIG. 2 are interconnected via a system bus 202. Additional subsystems include a printer 204, a keyboard 206, a fixed disk 208, and a monitor 210, which is coupled to a display adapter 212. Peripherals and input/output (I/O) devices, which couple to an I/O controller 214, can be connected to the computer system by any number of means known in the art, such as a serial port 216. For example, the serial port 216 or an external interface 218 can be utilized to connect the computer device 200 to further devices and/or systems not shown in FIG. 2 including a wide area network such as the Internet, a mouse input device, and/or a scanner. The interconnection via the system bus 202 allows one or more processors 220 to communicate with each subsystem and to control the execution of instructions that may be stored in a system memory 222 and/or the fixed disk 208, as well as the exchange of information between subsystems. The system memory 222 and/or the fixed disk 208 may embody a tangible computer-readable medium.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, R, Java, JavaScript, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

FIG. 3 is a block diagram of the specialty property index and recommendation engine 105 of FIG. 1 according to an embodiment of the subject matter disclosed herein. The specialty property index and recommendation engine 105 may include various programmatic modules and execution blocks for accomplishing various tasks and computations with the context of the system and methods discussed herein. As discussed above, this may be accomplished through the execution of computer-executable instructions stored on a non-transitory computer readable medium. To this end, the various modules and execution blocks are described next.

The specialty property index and recommendation engine 105 may include lists of data delineated by various identifications that are indicative of the type and nature of the information stored in the ordered lists. At the outset, these lists, in this embodiment, include a first list of lead data called DIM_LEAD 325. A lead includes data about an individual who is interested in acquiring rights and services at a specialty property and each record in DIM_LEAD 325 may be identified by a LEAD_ID. In this embodiment, the rights and services may include rents and personal care services at a senior living facility. In other embodiments, the specialty property is not necessarily a senior care facility or senior housing. The LEAD_ID may also include specific geographic data about a preferred location of a specialty property. The data that populates this list may be received at the specialty property index and recommendation engine 105 via a data collection module 321 that facilitates communications from various data collectors and third-party data providers as discussed with respect to FIG. 1. The information in DIM_LEAD 325 as described here may be collected chiefly by Senior Living Advisors, but could also be collected by third-party contractors (see data collectors 110 of FIG. 1).

Another list of data includes data about various properties in the pool of available or used specialty properties and this list is called DIM_PROPERY 326. The records in this list may include data about services provided at each property as well as cost data, availability, and specific location. DIM_PROPERY records may also include a history of property attributes over time for each PROPERTY_ID, so that leads can be matched to the property with each respective leads attributes. Records in DIM_PROPERY 326 are identified by a unique identifier called PROPERTY_ID. The data that populates this list may be received at the specialty property index and recommendation engine 105 via a data collection module 321 that facilitates communications from various data collectors and third-party data providers as discussed with respect to FIG. 1. DIM_PROPERTY 326 may be typically obtained from partners, operators, and property owners (117 of FIG. 1), but additional information about the property (such as its age, number of units of a given unit type, recent renovation, etc.) may come from 3rd party private or public sources (119 of FIG. 1).

Another list of data includes data about various geographic locations in the pool of available or used specialty properties and this list is called DIM_GEOGRAPHY 327. The records in DIM_GEOGRAPHY 327 may include data about the geographic locations of all properties such as ZIP code, Province code, county, city, metropolitan area, state, and region. The records here may also include data about weather associated with various geographic locations along with time and season factors. For example, one could collect data about time-stamped weather events to examine the impact of weather on the cost index. Records in this list are identified by a unique identifier called GEOGRAPHY_ID. The data that populates this list may be received at the specialty property index and recommendation engine 105 via a data collection module 321 that facilitates communications from various data collectors and third-party data providers as discussed with respect to FIG. 1. DIM_GEOGRAPHY 327 is collected from addresses of the properties, which are provided by partners, property owners, and operators (117 of FIG. 1), and addresses may be geotagged using public and private 3rd party sources (119 of FIG. 1) to acquire ZIP, county, city, metro, state, and region data.

All data from these various lists of data may be updated from time-to-time as various events occur or new data is collected or provided by various data collectors and third-party data providers via data collection module 321. As events take place, a new conglomerate list, FACT_LEAD_ACTIVITY 330, may be initiated and populated with various events that occur along with associated relevant data from the lists. Records in FACT_LEAD_ACTIVITY 330 include data with regard to lead events and move-in events. A lead event is defined as the event in which an advisor refers a specific property to a potential user of services. A move-in event is defined as an event in which a user of services moves into a recommended property from a lead. As such, the records will also include specific data about the dates of the activity underlying the event as well as specific data about the recommended property (e.g., cost, location, region, demographics of the area) and the user (or potential user) of services (e.g., demographics, budget, services desired, floor plans, community amenities, photos, and the like).

As mentioned, all data from these various lists of data may be updated from time-to-time as various events occur or new data is collected or provided by various data collectors and third-party data providers via data collection module 321. When an action takes place, such as a referral of a property to a lead or a lead moving into a referred property, an activity record may be created in the list FACT_LEAD_ACTIVITY 330. This information may include data drawn from the initial three lists discussed above when a specific action takes place. Thus, each record will include a LEAD_ID, a PROPERTY_ID, and a GEOGRAPHY_ID that may be indexed with additional data such as activity type (e.g., referral or move-in) and activity date. For example, a new inquiry may be made, a new lead may be generated, a new property may become part of the property pool, geographic data may be updated as ZIP codes or city/county lines shift, and the like. Further, collected data could be used to update or populate DIM_PROPERY 326, DIM_LEAD 325, DIM_GEOGRAPHY 327 and FACT_LEAD_ACTIVITY 330 in that collected data about economics, demography, and geography (including weather) may be assimilated in any of the lists discussed above.

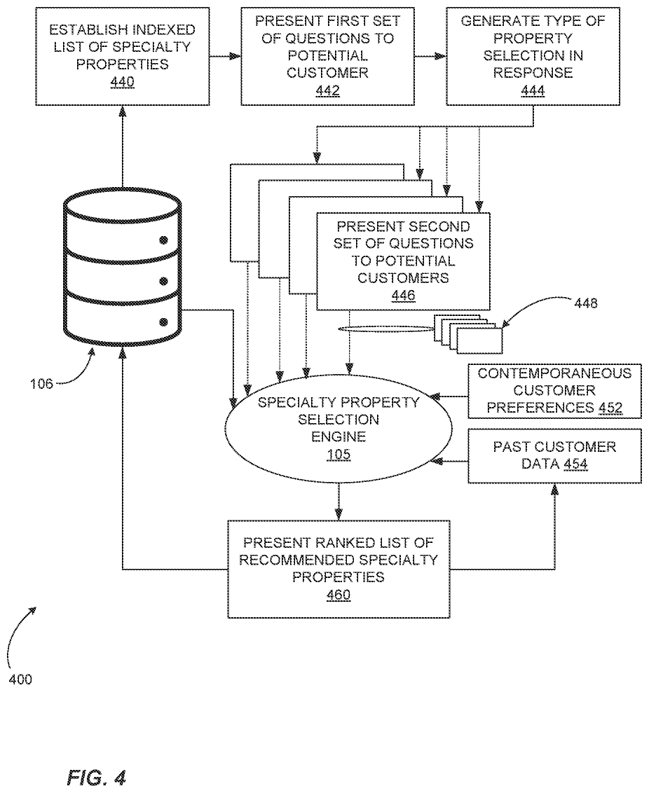

All data in FACT_LEAD_ACTIVITY 330 may be used by an analytics module 320 to generate several manners of data for use in the system. An operator may enter various analytical constraints and parameters using the operator input 322. The analytics module 320 may be manipulated such operator input to yield a desired analysis of the records stored in FACT_LEAD_ACTIVITY 330. Generally speaking, the data that may be assembled from the FACT_LEAD_ACTIVITY list 330 includes indexed referrals data 334 and indexed move-ins data 336. Such assembled data may be used to generate various cost and demand indexes and probabilities for a specialty property market across the several geographic, economic, and demographic categories. This useful indexed data across the operator desired constraints and parameters may then be communicated to other computing devices via communications module 340. One such useful way to utilize this indexed data is to provide recommendations to potential customers based on a multi-tiered query as described next with respect to FIG. 4.

FIG. 4 is a method flow chart 400 for using the system of FIG. 1 according to an embodiment of the subject matter disclosed herein. This computer-based method involves interactions between users of remote computing devices and various server system computers with the environment discussed above with respect to FIG. 1. Generally speaking, this method involves a multitiered and nested decision tree that typically involves at least 26 questions that are digitally presented to potential consumers utilizing a remote computing device (e.g., a smart phone, or the like). In other embodiments, there may be more or fewer than 26 overall questions. These multi-tiered queries may involve an initial set of first questions (6-8, for example) designed to zero-in on determining a specific type-of-care facility in which the potential customer is best suited to explore further. In other embodiments, there may be more or fewer than 6-8 initial questions. Then, based on the type-of-care determination, a specific second set of questions tailored to the initial determine of type-of-care may be presented to the potential customer in a second tier of questions to ultimately arrive at a ranked set of recommendations. This overall process may be implemented in a computer-based method as detailed in greater length below.

In FIG. 4, the method may begin by assembling or accessing an indexed list of specialty properties at step 440. As discussed above, this indexed list of specialty properties may have an ordered data structure such that all specialty properties may be stored concurrent with a number of attributes that can be searchable, rankable and indexable. Further, data that informs this index may be stored to and drawn from the data store 106 form the system of FIG. 1. Thus, as queries from a potential customer are collected, best-fit candidates among the specialty properties may be identified, ranked, and presented to the potential customer. The determination of this best fit approach may begin by presenting a first plurality of queries, at step 442, to the potential customer directed to assisting determining one or more types of specialty properties in which the potential customer may be best suited. Then, a series of individual web pages and/or screenshots may be presented to the potential customer so as to elicit input from the potential customer in response to the specific first set of questions. Upon receiving data from the potential customer in answer to the first plurality of queries about preferences for the one or more types of specialty properties, the specialty property index engine may determine a specific type-of-care specialty property from a top-level list of type-of-care categories at step 444. These type-of-care designations may be assisted living communities, continuing care retirement communities, adult daycare communities, home care services, respite services, skilled nursing care, long-term care, senior (55+) apartment living communities, retirement communities, independent care communities, and memory care facilities. At step 446, in response to the identification of one type-of-care facility, a second plurality of queries about the user's preferences directed to questions about the identified type-of-care of specialty property determined is presented to the potential customer's computing device. In this step, there may be several different sets of questions, each uniquely associated with the type-of-care designation determined at step 444. That is, the content and subject matter of the set of questions in the second set of questions may be predicated upon the determination of the type-of-care property from answers to the first set of questions. In some embodiments, a third set of questions 448 may also be utilized to even further drill down into a specific specialty property designations. In fact, any number of nested sets of questions may be presented in this multi-tiered approach to determination of the best suited specialty property for a potential customer.

No matter the number of iterations of follow-on tiers of questions after the initial type-of-care determination, ultimately, answer provided by the potential customer result in receiving data about the user's preferences for the identified type of specialty property, the specialty property index engine 105 may assimilate all inputs to generate results. In specific, the engine 105 may generate an identification of one or more recommendations for specialty properties within a set of properties that match the identified type-of-care properties and that are best suited to the user in response to the received data about the second (or more) plurality of queries. Further inputs to the engine 105 that may or may not influence the overall recommendations include additional contemporaneous customer preferences 452 (which may be the subject customer or other unrelated potential customers) and past customer data 454 (which may be the subject customer or other unrelated potential customers). Customer preferences 452 may include specific customer profile data such as “exclude this geographic area” or “only search in this State.” Similarly, past customer data 454 may include all previous data points for other potential customers and the influences of specific choices that lead to specific Move-In data.

Overall, the entire algorithmic engine 105, may then take all inputs, whether user-prompted or database-driven, and generate a ranked list of recommendations for specialty properties best suited to the potential customer. The ranked list of recommendations may be delineated by specific geographic region and interim and/or follow-on queries may be limited questions about one delineated geographic region. The recommendation engine may further delineate the indexed list by specific demographics by limiting the corresponding recommendations to one delineated demographic. The recommendation engine may further delineate the indexed list by specific econometrics by limiting the corresponding recommendations to one delineated econometric. The system and method further communicate, at step 460, the one or more recommendations to the remote computer of the potential customer and stores the one or more recommendations at the database 106 of the server computer in association with the potential customer. This entire interactive procedure may include data that is able to be received by and assimilated into database 106 that can be used to influence future unrelated interactions as well.

Aspects of the method described with respect to FIG. 4 may be embodied with the following example interaction between a server computer and a remote user computer. Such a workflow is presented in the following series of screen display descriptions:
Intro screen: Answer a few quick questions to compare personalized results.
Question 1—Who is in need of senior care?
   Question 1a—What is your loved one's name?
Question 2—What is your loved one's age?
Question 3—Where are you looking?
Question 4—What is the maximum distance you are willing to travel from preferred location?
Question 5—Where is your loved one currently living?
   Question 5a—Location Name (when applicable)
Question 6—How are they getting around?
   Question 6a: Wheelchair propel (when applicable).
   Question 6b: Wheelchair transfer (when applicable).
Question 7—Do they need assistance with any of the following (i.e., medication, toileting, bathing, etc.)?
   Question 7a: Medication details (when applicable).
   Question 7b: Diabetic care details (when applicable).
Question 8—Have they experienced any of these behaviors (i.e., wandering, aggressiveness, etc.)?
Question 9—Is your loved one currently experiencing memory loss?
   This example workflow may then determine that based on the responses, the selected senior living option best meets the loved one's needs comprises one of several type-of-care options. This may trigger a second set of directed questions, based on this initial determination that include:
Question 9—What are your room preferences within a community?
Question 10—What is the total cost of care you believe you can afford?
Question 11—Is your loved one a veteran or the spouse of a veteran?
Question 12—How do you or your loved one plan to pay for care?
Question 13: Does your loved one currently have a Long-Term Care insurance policy? (when applicable)
Question 14—How quickly do you need to find care?
Question 15—Is Walkability of a neighborhood important?
Question 16—Are entertainment options of the community important?
Question 17—Is weather and climate an important aspect?
Question 18—Enter contact information to get personalized results.
Question 19—Are they on Medicaid and/or Medicare?
Question 20—Do they prefer to obtain assistance from an APFM Senior Living Advisor or work directly with our partner communities?

Based on all of the previous tiered queries and responses, a personalized list of recommendations may be presented to the potential customer via the very computing device that is being utilized by the user. In some embodiments, an eligibility determination is made before recommendations are shared with prospective users. Such eligibility determinations may also include determining if a designated region has statutory requirements that prevent offerings of services or if the inquirer is already engaged in a previous inquiry. This list may be indexed as a matter of ranked best fit modelling from the overall index of specialty properties as previously assembled. Further, there is no requirement that the first set of queries be asked in any specific order or even prior to any questions from the second or subsequent sets of questions. In one embodiment, all questions are initially asked and answered even if a specific subset (e.g., a first plurality) is analyzed first to arrive determination of type-of-care in order to trigger a follow-on analysis of some or all of the remaining question (e.g., a second plurality) to arrive at the recommendations.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

1. A computer-based method for improving efficiency of interactive communications for prospective customers of specialty properties, the method comprising:
establishing an indexed list of specialty properties at a server computer;
presenting a first plurality of queries to an end user on a computing device that is remote from the server computer and communicatively coupled to the server computer through a computer network, the first plurality of queries directed to questions to the end user to assist with identifying one or more types of specialty properties;
updating the indexed list of specialty properties with data about the presenting of the first plurality of queries;
receiving data from the user in answer to the first plurality of queries, at the server computer, about the user's preferences for the one or more types of specialty properties;
generating, at the server computer, an identification of a type of specialty property best suited to the user in response to the received data from the first plurality of queries;
in response to the identification, presenting a second plurality of queries uniquely associated with the identification, the second plurality of queries directed to questions to the end user to assist users' preferences about the identified type of specialty property;
updating the indexed list of specialty properties with data about the presenting of the second plurality of queries while maintaining data in the indexed list of specialty properties associated with unpresented queries that are not uniquely associated with the identification;
receiving data from the user in answer to the second plurality of queries, at the server computer, about the user's preferences for the identified type of specialty properties;
generating, at the server computer, an identification of one or more recommendations for specialty properties within a set of properties that match the identified type of properties and that are best suited to the user in response to the received data about the second plurality of queries;
updating the indexed list of specialty properties with identification of one or more recommendations for specialty properties within a set of properties that match the identified type of properties and that are best suited to the user in response to the received data about the second plurality of queries; and
communicating the one or more recommendations to the remote computer and storing the one or more recommendations at the server computer in association with the user.

2. The computer-based method of claim 1, wherein the identified type of specialty property may be one of the group composed of assisted living communities, continuing care retirement communities, adult daycare communities, home care services, respite services, skilled nursing care, long-term care, senior (55+) apartment living communities, retirement communities, independent care communities, and memory care facilities.

3. The computer-based method of claim 1, wherein the first plurality of queries includes at least one of the group composed of: mobility of a potential customer, need for living assistance of a potential customer, medical conditions of a potential customer, social behaviors of a potential customer, and state of memory of a potential customer.

4. The computer-based method of claim 1, further comprising:
in response to the receiving answer to the second plurality of queries, presenting a third plurality of queries about a second set of user's preferences, the third plurality of queries directed to preferences corresponding to a determination made after the second set plurality of queries; and
receiving data from the user in answer to the third plurality of queries, at the server computer, about the second set of user's preferences.

5. The computer-based method of claim 1, further comprising assimilating past unrelated user response data to influence the second plurality of queries that is presented in response to the determination of the type of specialty property.

6. The computer-based method of claim 1, further comprising assimilating contemporaneous unrelated user response data to influence the second plurality of queries that is presented in response to the determination of the type of specialty property.

7. The computer-based method of claim 1, further comprising delineating indexed list by specific geographic region and limiting queries used in generating the recommendations to one delineated geographic region.

8. The computer-based method of claim 1, further comprising delineating the indexed list by specific demographics and limiting the corresponding recommendations to one delineated demographic.

9. The computer-based method of claim 1, further comprising delineating the indexed list by specific econometrics and limiting the corresponding recommendations to one delineated econometric.

10. The computer-based method of claim 1, further comprising a determining a likelihood that a potential customer corresponds to a real human and suspending queries if the likelihood determined falls below a threshold.

11. A computer system for improving efficiency of interactive communications for prospective customers of specialty properties, the computer system comprising:
a remote user computer coupled to a computer network and configured to collect inquiry data from a user inquiring about one or more specialty properties;
a server computer coupled to the computer network and configured to collect potential customer data and to maintain and update an indexed list of specialty properties; and
a specialty property recommendation engine having computer-readable instructions that when executed by a computer processor at the server computer, causes the system to:
present a first plurality of queries to an end user on a computing device that is remote from the server computer and communicatively coupled to the server computer through a computer network, the first plurality of queries directed to identifying one or more types of specialty properties;
update the indexed list of specialty properties with data about the presentation of the first plurality of queries;
receive data from the user in answer to the first plurality of queries, at the server computer, about the user's preferences for the one or more types of specialty properties;
generate, at the server computer, an identification of a type of specialty property best suited to the user in response to the received data from the first plurality of queries;
in response to the identification, present a second plurality of queries uniquely associated with the identification, the second plurality of queries directed to users' preferences about the identified type of specialty property;
updating the indexed list of specialty properties with data about the presentation of the second plurality of queries while maintaining data in the indexed list of specialty properties associated with unpresented queries that are not uniquely associated with the identification;
receive data from the user in answer to the second plurality of queries, at the server computer, about the user's preferences for the identified type of specialty properties;
generate, at the server computer, an identification of one or more recommendations for specialty properties within a set of properties that match the identified type of properties and that are best suited to the user in response to the received data about the second plurality of queries;
update the indexed list of specialty properties with identification of one or more recommendations for specialty properties within a set of properties that match the identified type of properties and that are best suited to the user in response to the received data about the second plurality of queries; and
communicate the one or more recommendations to the remote computer and storing the one or more recommendations at the server computer in association with the user.

12. The computer system of claim 11, wherein the identified type of specialty property may be one of the group composed of assisted living communities, continuing care retirement communities, adult daycare communities, home care services, respite services, skilled nursing care, long-term care, senior (55+) apartment living communities, retirement communities, independent care communities, and memory care facilities.

13. The computer system of claim 11, wherein the first plurality of queries includes at least one of the group composed of: mobility of a potential customer, need for living assistance of a potential customer, medical conditions of a potential customer, social behaviors of a potential customer, and state of memory of a potential customer.

14. The computer system of claim 11, wherein the specialty property recommendation engine is further configured to:
present a third plurality of queries about a second set of user's preferences in response to the received answers to the second plurality of queries, the third plurality of queries directed to preferences corresponding to a determination made after the second set plurality of queries; and
receive data from the user in answer to the third plurality of queries, at the server computer, about the second set of user's preferences.

15. The computer system of claim 11, wherein the specialty property recommendation engine is further configured to assimilate past unrelated user response data to influence the second plurality of queries that is presented in response to the determination of the type of specialty property.

16. The computer system of claim 11, wherein the specialty property recommendation engine is further configured to assimilate contemporaneous unrelated user response data to influence the second plurality of queries that is presented in response to the determination of the type of specialty property.

17. The computer system of claim 11, wherein the specialty property recommendation engine is further configured to delineate indexed list by specific geographic region and limiting queries used in generating the recommendations to one delineated geographic region.

18. The computer system of claim 11, wherein the specialty property recommendation engine is further configured to delineate the indexed list by specific demographics and limiting the corresponding recommendations to one delineated demographic.

19. The computer system of claim 11, wherein the specialty property recommendation engine is further configured to delineate the indexed list by specific econometrics and limiting the corresponding recommendations to one delineated econometric.

20. The computer system of claim 11, further comprising an analysis muddle coupled to the server computer configured to determine a likelihood that a potential customer corresponds to a real human and configured to suspend queries if the likelihood determined falls below a threshold.
